(19) United States
(12) Patent Application Publication
(10) Pub. No.: US 2005/0174461 A1
(43) Pub. Date: Aug. 11, 2005

(54) Digital video camera

(75) Inventor: Ming-Chieh Liu, Taipei (TW)

Correspondence Address: BIRCH STEWART KOLASCH & BIRCH, PO BOX 747, FALLS CHURCH, VA, 22040-0747, US

(73) Assignee: PREMIER IMAGE TECHNOLOGY CORPORATION, Taipei (TW)

(21) Appl. No.: 11/004,849

(22) Filed: Dec. 7, 2004

(30) Foreign Application Priority Data
Feb. 11, 2004 (TW) 093201962

(51) Int. Cl. H04N 5/222

(52) U.S. Cl. 348/333.06

(57) ABSTRACT

A digital video camera comprising a LCD monitor, is foldable and flip up in arbitrary direction with two axes, wherein the first axis is coaxial or parallel to the camcorder lens, and the second axis is in a position which is deviated from the middle point of the frame of LCD monitor. Therefore, the LCD monitor can flip up in arbitrary direction without the limitation from the axes.

### FIELD OF THE INVENTION

The present invention relates to a structure of digital video camera or a camcorder; and, more specifically, to a digital video camera with a LCD monitor which can be flip up in arbitrarily direction.

### BACKGROUND OF THE INVENTION

The digital video camera or camcorder available in the market now, has a LCD monitor respectively; however, before use, all of the LCD monitors should to flip up in a predetermined direction first, either along the vertical axis or the horizontal axis thereof, as shown in FIG. 1 and FIG.2.

Referring to FIG. 1 again, the connector (11) is mounted on the frame center of the LCD monitor (10), thus led to made the LCD monitor (10) needs to flip up along the horizontal axis first, and then the vertical axis next. Accordingly, the LCD monitor (10) should starts along the flipping path (12) vertically to reach a horizontal position, and thus cannot start from the path (13) directly.

As shown in FIG. 2, a second known design LCD monitor (20) is equipped with a connector (21) which is mounted on the frame center of the LCD monitor (20), and needs to flip up along the vertical axis at first, and then along the horizontal axis, as shown as the path (22) and path (23).

Currently, none of the digital video camera or camcorder has a LCD monitor that can flip up in arbitrarily direction.

### SUMMARY OF THE INVENTION

It is one object of the present invention to provide a digital video camera or camcorder which is equipped with a LCD monitor that can flip up in arbitrarily direction.

According to the present invention, a LCD monitor is connected to a digital video camera's body through two axes, wherein the first axis is coaxial or parallel to the camcorder lens and the second rotating axis is installed on the frame of the LCD monitor at a location that is deviating from the frame center thereof. Therefore, the user can flip up the LCD monitor freely in arbitrarily direction without the limitation from the axes.

### DESCRIPTION OF THE DRAWINGS

The foregoing description or other characteristics, objects, features and advantages of the present invention will become more apparent upon consideration of the following detailed description, having reference to the accompanying drawings wherein;

FIG. 1 is a perspective view illustrates the structural and operation of LCD monitor for the first known Digital video camera;

FIG. 2 is a perspective view illustrates the structural and operation of LCD monitor for another known Digital video camera;

FIG. 3 is a perspective view illustrates an embodiment in accordance with the present invention;

FIG. 4 is a perspective view illustrating an operation of the embodiment in accordance with the present invention;

FIG. 5 is another perspective view illustrating an operation of the embodiment in accordance with the present invention;

FIG. 6 is a perspective view illustrating the second operation of the embodiment in accordance with the present invention;

FIG. 7 is another perspective view illustrating the second operation of the embodiment in accordance with the present invention; and

FIG. 8 is a perspective view of another embodiment in accordance with the present invention.

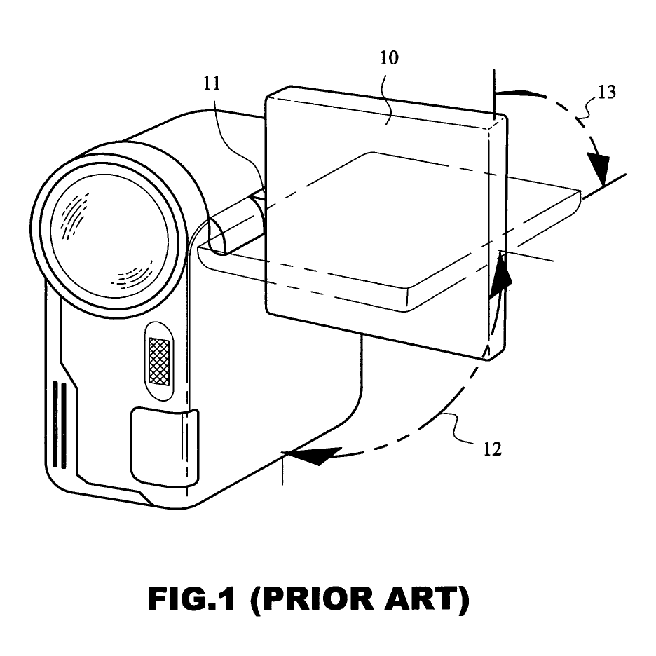

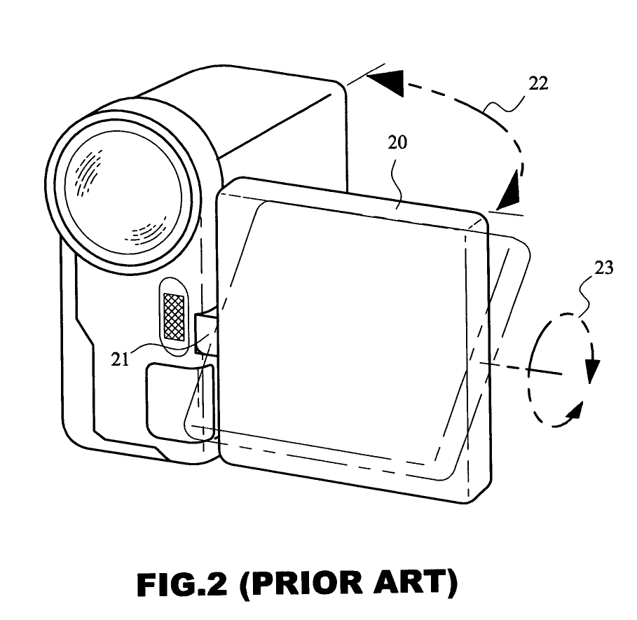

### DETAILED DESCRIPTION OF THE PREFERRED EMBODIMENT

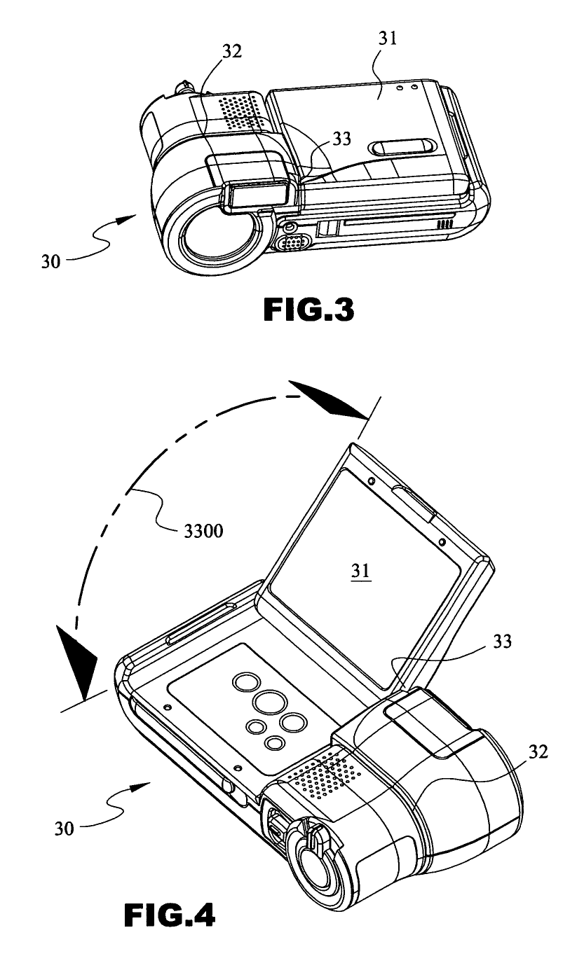

As shown in FIG. 3, an embodiment of Digital video camera (30) according to the present invention may equipped with the necessary accessory of any Digital video camera, is including but not limited to the ordinary components on the camera body such as optical lens, flash lamp, microphone, video and audio output port memory unit, DVD or magnetic tape, etc. Among them, there is a connector (32) positioning between the optical lens sleeve and the camera body; further, another connector (33) is mounted on the middle frame of the LCD monitor (20).

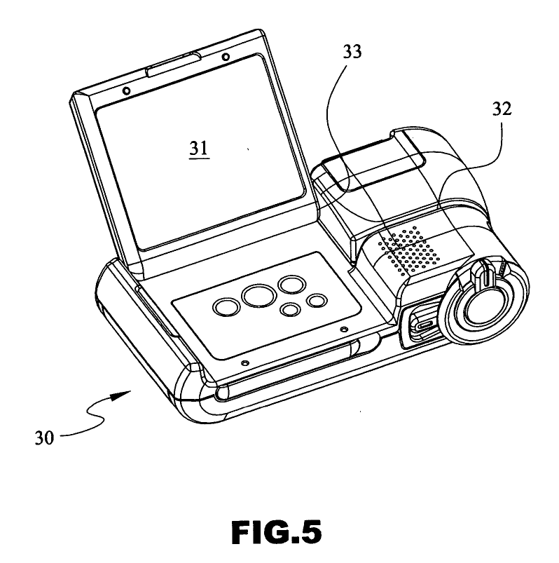

As shown in FIG. 4 to FIG. 6, an embodiment of the digital video camera (30) can be put on the table horizontally, wherein the LCD monitor (20) can be flipped up along the axis at the connector (33) and moving along the path (3300). When take a picture or play the content in the memory of the digital video camera (30), the LCD monitor (20) can be flip up akin to a monitor of a notebook computer. Such a convenience has never shown in any digital video camera as which is available in the market.

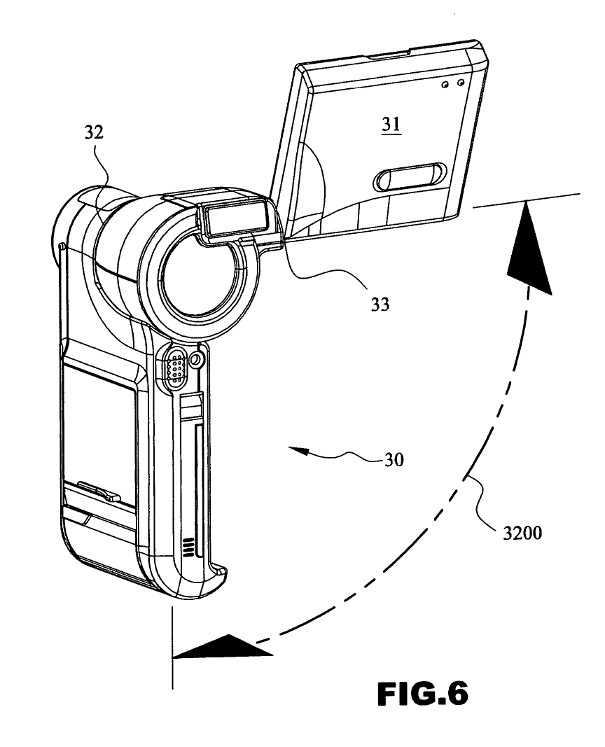

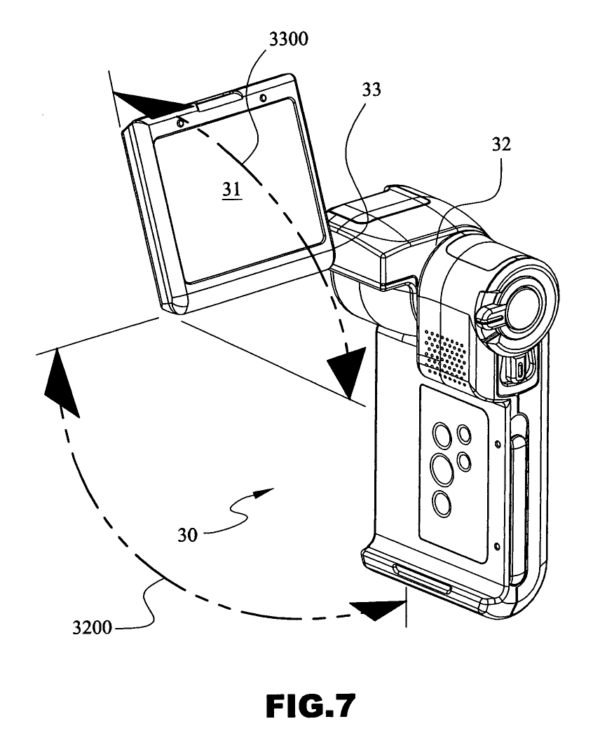

Referring to FIG. 6 and FIG. 7, the LCD monitor (20) of a digital video camera (30) is flip up by rotate along the axis of the connector (32) as indicated as the path (3200), then to adjust the angle of the LCD monitor (20) by rotate with path (3300).

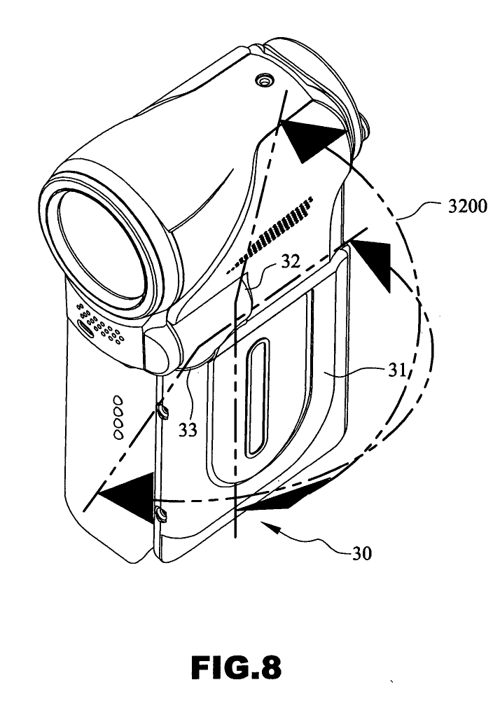

According to the present invention, a connector is pivotably connect the LCD monitor (20) and the Digital video camera (30). As illustrated in FIG. 8, shown a connector which pivotably connect the LCD monitor (31) to the outer surface of the optical lens sleeve; for instance, to connect it to a connector protruding from the camera body shell.

For all, the LCD monitor structure in accordance with the present invention, can allow users to flip up the monitor in arbitrarily axis without structural limitation.

This description is intended to provide specific examples of individual embodiments which clearly disclose the present invention. Accordingly, the invention is not limited to these embodiments or to the use of elements having the specific configurations and shapes as presented herein. All alternative modifications and variations of the present invention which fall within the spirit and broad scope of the appended claims are included.

1. A digital video camera equipped with a LCD monitor, comprising
a first connector which is pivotably connected an optical lens sleeve and a body of the digital video camera; and
a second connector which is pivotably connected the optical lens sleeve and the LCD monitor, wherein the LCD monitor has a frame, and the position of the second connector is deviating from the middle portion of the frame.

2. The digital video camera in accordance with claim 1, wherein the first connector has a first axis, and the liquid crystal monitor can rotate to adjust angle along the first axis.

3. The digital video camera in accordance with claim 1, wherein the second connector has a second axis and the liquid crystal monitor can rotate along the second axis to adjust angle.

4. The digital video camera in accordance with claim 2, wherein the second connector has a second axis and the liquid crystal monitor can rotate along the second axis to adjust angle.

5. A digital video camera equipped with a LCD monitor, comprising
a frame for fixing the LCD monitor; and
a connector which has one end pivotably connected the body of the digital video camera and has another end pivotably connected the frame at a position close to the corner of the LCD monitor.

6. The digital video camera in accordance with claim 5, wherein the connector is connected to the optical lens sleeve of the digital video camera.

7. The digital video camera in accordance with claim 6, wherein the connector and the optical lens sleeve of the Digital video camera are integally formed together.

8. The digital video camera in accordance with claim 5, wherein the outer surface of the optical lens sleeve has a protrusion which is used to connect with the connector; therefore, the LCD monitor can rotate relatively to the optical lens sleeve.

9. The digital video camera in accordance with claim 5, wherein the camera body having a outer shell for connecting with the connector; such that allowing the LCD monitor to flip relative to the camera body.

10. The digital video camera in accordance with claim 5, wherein the camera body has a outer shell equipped with a second connector which is pivotably connect to the connector, and allowing the LCD monitor to flip up relatively to the camera body.
